(19) United States
(12) Patent Application Publication
(10) Pub. No.: US 2011/0198880 A1
(43) Pub. Date: Aug. 18, 2011

(54) Locking mechanism for cargo compartment cover

(76) Inventor: Lynn Chenowth, Rodeo, NM (US)

(21) Appl. No.: 12/705,396

(22) Filed: Feb. 12, 2010

(51) Int. Cl. B60P 7/04

(52) U.S. Cl. 296/98; 292/305

(57) ABSTRACT

In a hauling vehicle having a cargo compartment that can be covered by a pliable sheet canopy deployable from a reel mounted at one end of the compartment, a mechanism located at the opposite end of the compartment automatically grabs and locks a rod commonly found at the leading edge of the canopy. The locking mechanism is automatically released upon actuation of the very switch that triggers the retracting of the canopy. Pincer prongs automatically swing around opposite end sections of the rod and are immobilized by spring-biased pins. The pins are pulled back by solenoids energized upon actuation of the switch.

### FIELD OF THE INVENTION

This invention relates apparatuses used to deploy and retract a protective pliable sheet canopy over the cargo compartment of a hauling vehicle, and more specifically to mechanisms for positively and securely keep such a canopy into its deployed position.

### BACKGROUND

Automatically deploying and retracting covers for hauling vehicle compartments are well known and exemplified in the prior art by the apparatus disclosed in U.S. Patent Application Publication No. US 2007/0102951 which is incorporated herein by reference.

It is imperative that such a cover be securely tied down during travel of the vehicle to avoid being ripped open or blown away by a wind draft. A variety of fastening implements currently in use requires time-consuming manual operations once the cover has been deployed, and additional manual interventions to release the fastening devices before the cover can be retracted.

The instant invention results from an attempt to automate these cover fastening and releasing operations.

### SUMMARY

The principal and secondary objects of the invention are to provide an improved locking mechanism for retractable cover for cargo containers. These and other objects are achieved by a mechanism for immobilizing the free end of the cover in a deployed position, and a switch for simultaneously releasing the mechanism and retracting the cover.

In some embodiments there is provided a cargo cover locking device that includes a mechanism that automatically wraps a hook around the ends of the rod, and is locked by a spring biased pin that is pushed into an aperture in the hook. In some embodiments a solenoid energized upon the actuation of a canopy retraction switch withholds the pin releasing the hook without further manipulation by the operator.

In some embodiments there is provided that in a vehicle having a cargo compartment coverable by a canopy spread between a take up reel and a pulling rod, said rod being translatable from a rewound position at a first end of said compartment to a deployed position at an opposite second end, an improvement which comprises: a mechanism for immobilizing said rod in said deployed position; and a switch operable to initiate a retracting movement of said canopy and simultaneously release said mechanism.

In some embodiments the mechanism comprises: a spring-biased locking pin; and a solenoid positioned to withdraw said pin upon activation of said switch.

In some embodiments a U-shaped support cradle is dimensioned and positioned to nest a section of said rod in said deployed position, said cradle having a base and first and second arms projecting from said base; a hook having a median region rotatively secured to said first arm, a prong and a leg extending astride said region toward said second arm, wherein an upper part of said leg rises above said base in an open position of said hook; a coil spring stretched between said second arm and said leg and biasing said prong toward said open position; said pin being journaled into a bore in said base and having a distal end; said leg having an aperture positioned to be engaged by said distal end in said locked position; a proximal part of sais pin extending into said solenoid; a guiding pintle, of a smaller cross-diameter than said distal end and projecting co-axially from said distal end; and said leg having a arcuate slot commensurately engaged by said pintle and terminating in said aperture.

In some embodiments a C-washer fixedly engaged around said pin; and, a coil spring compressed between said solenoid and said washer.

In some embodiments the mechanism is positioned to receive opposite end sections of the rod.

In some embodiments there is provided a mechanism for securing a rod at the leading edge of a deployed canopy comprises: a pincer assembly shaped and positioned to be forced into a locking position around the rod upon contact with the rod; a locking pin; a spring resiliently pushing sais pin; a solenoid positioned to withdraw said pin when energized; a switch simultaneously controlling said solenoid and a retracting movement of the canopy; and means for resiliently biasing said assembly toward an unlocking position.

### BRIEF DESCRIPTION OF THE DRAWINGS

FIG. 1 is a block diagram of the canopy cover control; apparatus;

FIG. 2 is a perspective view of the rod locking mechanism;

FIG. 3 is a side view of the locked mechanism; and

FIG. 4 is a cross-sectional view of the locking assembly.

### DESCRIPTION OF THE EXEMPLARY EMBODIMENTS

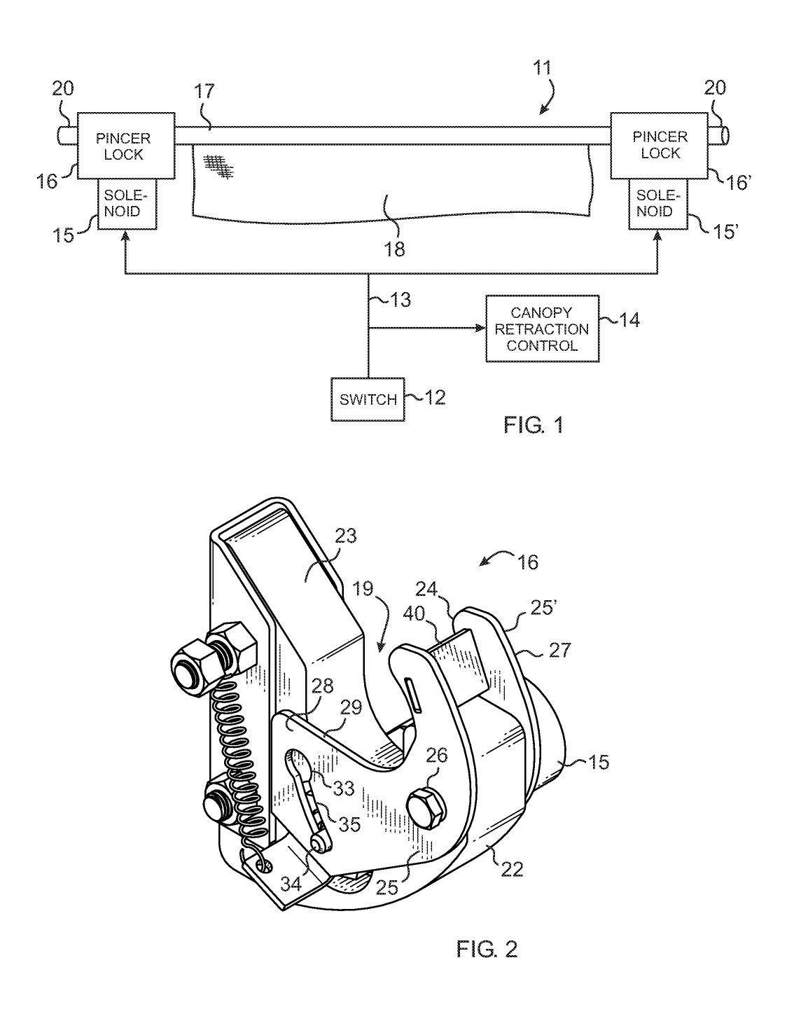

Referring now to the drawing, there is illustrated in FIG. 1 an apparatus 11 for covering a truck cargo compartment with a pliable sheet canopy. The apparatus comprises a switch 12 which, upon activation, generates a signal 13 that activates a canopy retracting control unit 14 and at the same time energizes a pair of solenoids 15, 15′ used to release a couple of canopy locking devices 16, 16′.

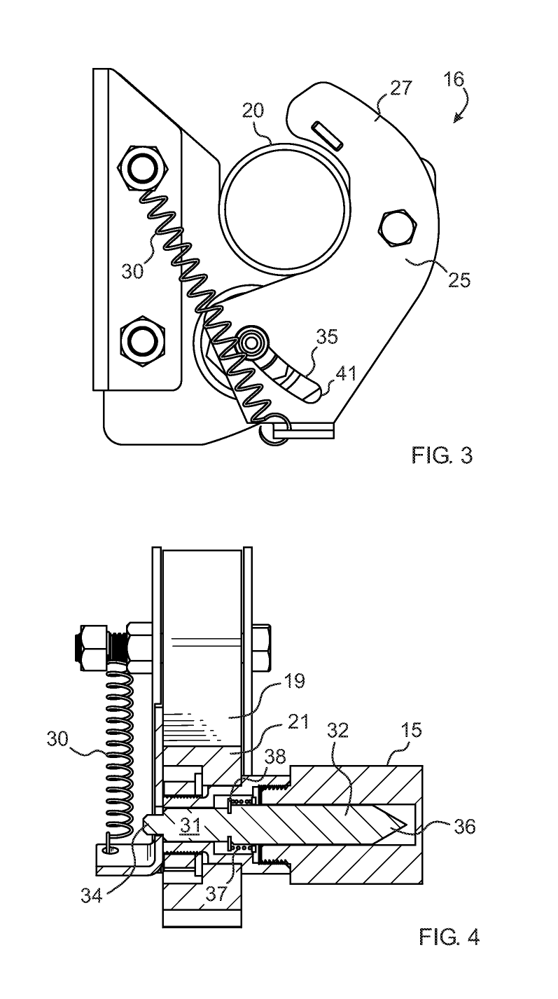

As more specifically shown in FIGS. 2-4, each locking device comprises a pincer mechanism shaped and positioned to grab and firmly hold one of the opposite ends of a rod 17 commonly found at the leading edge of the pliable sheet canopy 18 until released by the pull of the solenoids 15, 15′.

Each locking device comprises a U-shaped support cradle 19 dimensioned to nest an end section 20 of the rod 17 when the canopy reaches its fully deployed position. The cradle comprises a base 21 and first 22 and second 23 arms projecting upwardly from the opposite extremities of the base.

A hook structure 24, made of parallel first 25 and second 25′ plates joined by a spanning bracket 40, has its median region rotatively secured to the first arm 22 by a screw and spacer assembly 26. Projecting arcuately astride the median region of the hook and toward the second arm are a prong 27 and a leg 28. The prong is dimensioned to wrap around the end section 20 of the rod in the locked position of the device. The upper part 29 of the leg rises slightly above the base 21 of the cradle in the open position of the device as shown in FIG. 2.

When the rod section 20 drops into the cradle it contacts and applies a downward pressure upon the upper part of the leg, causing the hook to rotate around the screw and spacer assembly 26. As the prong 27 swings around the rod section, it locks it into the cradle.

The device is normally kept in the unlocked position by a coil spring 30 stretched between the second arm 23 and the leg 28.

The distal end 31 of a spring biased locking pin 32 journaled into a bore in the base 21 of the cradle is pushed into an aperture 33 in the first plate 25 of the hook at the end of the closing movement of the hook as explained below. The operation of the device is stabilized by a pintle 34 of a lesser cross-diameter than the distal end of the pin that projects coaxially from it and engages an arcuate slot 35 terminating into the aperture 33.

The proximal part 36 of the pin extends into one of the solenoids 15. A pin-biasing coil spring 37 is compressed between the solenoid and a C-washer 38 fixedly crimped to a median section of the pin.

When the solenoid is energized it withdraws the locking pin 32 from the aperture 33 allowing the coil spring 30 to pull the hook into an open position. As this action is simultaneously combined with the initiation of the retracting movement of the canopy, the leading rod 17 free of any restraint can be pulled back in a uncovering maneuver. The upper part 29 of the leg contacting the rod section 20 can thus help dislodge the rod section from the base 21 while the hook moves into the open position. When the hook 24 is in the fully open position the pintle 34 remains in the end 41 of the slot 35 opposite the aperture 33 in order to both prevent the hook from rotating beyond a preferred open location, and to maintain alignment of the pin 32 so that the its distal end 31 can properly re-engage the aperture 33 when the hook is pushed into the locking position by the forcefully engaging rod section.

While the exemplary embodiments of the invention have been described, modifications can be made and other embodiments may be devised without departing from the spirit of the invention and the scope of the appended claims.

1. In a vehicle having a cargo compartment coverable by a canopy spread between a take-up reel and a pulling rod, said rod being translatable from a rewound position at a first end of said compartment to a deployed position at an opposite second end, an improvement which comprises:
a mechanism for immobilizing said rod in said deployed position; and
a switch operable to initiate a retracting movement of said canopy and simultaneously release said mechanism.

2. The improvement of claim 1, wherein said mechanism comprises:
a spring-biased locking pin; and
a solenoid positioned to withdraw said pin upon activation of said switch.

3. The improvement of claim 2, wherein said mechanism further comprises:
a U-shaped support cradle dimensioned and positioned to nest a section of said rod in said deployed position, said cradle having a base and first and second arms projecting from said base;
a hook having a median region rotatively secured to said first arm, a prong and a leg extending astride said region toward said second arm, wherein an upper part of said leg rises above said base in an open position of said hook;
whereby said rod section contacting and pressing against said upper part causes said prong to swing around said section of the rod into a locked position of said mechanism.

4. The improvement of claim 3, wherein said mechanism further comprises a coil spring stretched between said second arm and said leg, said coil spring biasing said prong toward said open position.

5. The improvement of claim 4, wherein said mechanism further comprises:
said pin being journal-led into a bore in said base and said pin having a distal end;
said leg having an aperture positioned to be engaged by said distal end in said locked position; and
a proximal part of said pin extending into said solenoid.

6. The improvement of claim 5, wherein said mechanism further comprises:
a guiding pintle, of a smaller cross-diameter than said distal end, projecting co-axially from said distal end; and
said leg having an arcuate slot commensurately engaged by said pintle and terminating in said aperture.

7. The improvement of claim 5, wherein said mechanism further comprises:
a C-washer fixedly engaged around said pin; and
a coil spring compressed between said solenoid and said washer.

8. The improvement of claim 3, including two of said mechanism positioned to receive opposite end sections of said rod.

9. A mechanism for securing a rod at the leading edge of a deployed canopy, said mechanism comprising:
a pincer assembly shaped and positioned to be forced into a locking position around said rod upon contact with said rod;
a locking pin;
a spring resiliently pushing sais pin; and
a solenoid positioned to withdraw said pin when energized.

10. The mechanism of claim 9, which further comprises a switch simultaneously controlling said solenoid and a retracting movement of said canopy.

11. The mechanism of claim 10, which further comprises means for resiliently biasing said assembly toward an unlocking position.

12. The mechanism of claim 11, wherein said pincer assembly comprises:
a U-shaped support cradle dimensioned and positioned to nest a section of said rod in a deployed position of said canopy, said cradle having a base and first and second arms projecting from said base;
a hook having a median region rotatively secured to said first arm, a prong and a leg extending astride said region toward said second arm, wherein an upper part of said leg rises above said base in an open position of said hook;
whereby said rod section contacting and pressing against said upper part causes said prong to swing around said section of the rod into a locked position of said pincer assembly.

13. The improvement of claim 12, wherein said mechanism further comprises a coil spring stretched between said second arm and said leg and biasing said prong toward said open position.

14. The improvement of claim 13, wherein said mechanism further comprises:
said pin being journaled into a bore in said base and having a distal end;
said leg having an aperture positioned to be engaged by said distal end in said locked position; and
a proximal part of said pin extending into said solenoid.

15. The improvement of claim 14, wherein said mechanism further comprises:
a guiding pintle, of a smaller cross-diameter than said distal end and projecting co-axially from said distal end; and
said leg having an arcuate slot commensurately engaged by said pintle and terminating in said aperture.

16. The improvement of claim 14, wherein said mechanism further comprises:
a C-washer fixedly engaged around said pin; and
a coil spring compressed between said solenoid and said washer.

17. The improvement of claim 9, including two of said mechanism positioned to receive opposite end sections of said rod.
